(19) United States
(12) Patent Application Publication
(10) Pub. No.: US 2012/0311562 A1
(43) Pub. Date: Dec. 6, 2012

(54) EXTENDABLE EVENT PROCESSING

(76) Inventors: Yanlin Wang, San Jose, CA (US); Hugh Njemanze, Los Altos, CA (US); Dhiraj Sharan, Sunnyvale, CA (US)

(21) Appl. No.: 13/285,903

(22) Filed: Oct. 31, 2011

Related U.S. Application Data
(60) Provisional application No. 61/492,229, filed on Jun. 1, 2011.

(51) Int. Cl. G06F 9/445; G06F 9/46

(52) U.S. Cl. 717/177

(57) ABSTRACT

A system for extending event processing in an information and event management system includes an event stream application engine. The event stream application engine manages event stream applications, which includes installing the event stream applications in the information and event management system. The installed event stream applications are available to be deployed in an event data processing run-time environment to process event data received at the information and event management system. The system includes an event process extender to the event stream applications in an event stream processing workflow. Each event stream application in the workflow is to process the event data if the event stream application determines the event data to be relevant to processing performed by the event stream application..

### PRIORITY

The present application claims priority to U.S. provisional application Ser. No. 61/492,229, filed Jun. 1, 2011, which is incorporated by reference in its entirety.

### BACKGROUND

Network security management is generally concerned with collecting data from network devices that reflects network activity and operation of the devices, and analyzing the data to enhance security. For example, the data that is collected may originate in messages or in entries in log files generated by sources, such as the network devices and applications, which may include firewalls, intrusion detection systems, servers, routers, switches, etc. The data can be analyzed to identify an attack on the network. If the attack is ongoing, a countermeasure can be performed to thwart the attack or mitigate the damage caused by the attack.

Network security management systems, in most instances, are limited to managing network security. Thus, their functionality is generally limited and non-extendable to managing non-network security events.

### BRIEF DESCRIPTION OF DRAWINGS

The embodiments are described in detail in the following description with reference to the following figures.

FIG. 1 illustrates an environment including a security information and event management system, according to an embodiment;

FIG. 2 illustrates a method for installing an event stream application, according to an embodiment;

FIG. 3 illustrates a method for processing event data by an event stream application, according to an embodiment; and

FIG. 4 illustrates a computer system that may be used for the methods and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent that the embodiments may be practiced without limitation to all the specific details. Also, the embodiments may be used together in various combinations.

According to an embodiment, a security information and event management (SIEM) system includes an extendable event process platform. An event stream application (ESA) engine and an event process extender allows the SIEM to operate as the extendable event process platform. The ESA engine enables users to create and deploy event stream applications (ESAs) into the SIEM to enrich the event processing performed by an event processing engine at the SIEM with functionality that may be application-specific, industry-specific, or related to any type of domain. Also, the ESA engine may mange the ESAs, such as performing dependency management, versioning, and ESA lifecycle management.

An ESA is an application for processing events according to the machine readable instructions in the application. The ESAs may extend the functionality of the SIEM beyond network security. For example, ESAs may be used to provide fraud detection in business transactions, or to monitor telephone calls or messaging in a telecommunications system, or to provide functionalities in other industries and systems. Furthermore, the ESAs operating with the event process extender allow the SIEM to communicate with and leverage processing performed in ESAs which may interact with external systems, and then the processed data may be provided to the SIEM event processing engine for correlation and further analysis. Also, ESAs may be operable to incorporate the computation from an external system into event processing. In other words, the input of ESAs may be event data from the SIEM event flow, and the output of the ESAs may still include the event data but the event data is enriched by the external system processing. Enriching may include modifying data in one or more event fields. The ESAs may pre-process event data prior to processing by an event processing engine or prior to persisting data in data storage in the SIEM or the ESAs may post-process the event data after processing by the event processing engine or after persisting data in the data storage.

An ESA may also determine if it is to process certain event data based on rules or instructions in the ESA. If the ESA determines the event data includes data to be processed, it processes the event data. Otherwise, the ESA will not process the event data but the event data may be processed by an event processing engine. This allows the SIEM to handle processing for multiple domain's (e.g., network security, online transaction, health insurance, etc.) simultaneously.

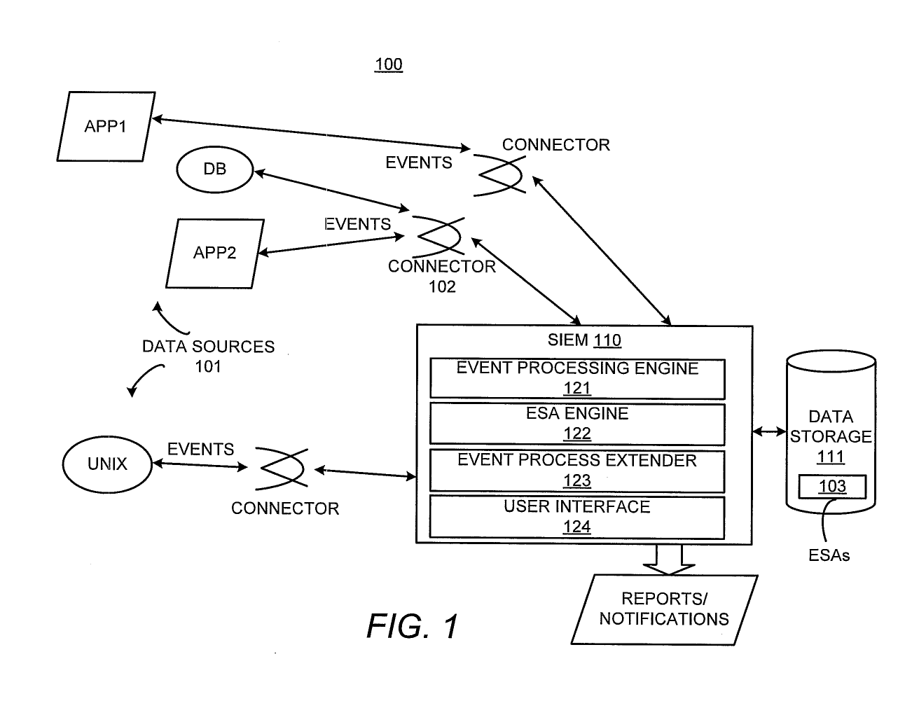

FIG. 1 illustrates an environment 100 including an SIEM 110, according to an embodiment. The SIEM 110 is a system that processes event data, which may include real-time event processing. The SIEM 110 may process the event data to determine network-related conditions, such as network security threats. The event data processing is extended to include other functionality and event data processing through the ESAs. Also, the SIEM 110 is described as a security information and event management system by way of example. As indicated above, the system 110 is an information and event management system, and it may perform event data processing related to network security as an example. It is operable to perform event data processing for events not related to network security. The environment 100 includes data sources 101 generating event data for events, which are collected by the SIEM 110 and stored in the data storage 111. The data storage 111 may include a database or other type of data storage system. The data storage 111 may include memory for performing in-memory processing and/or non-volatile storage for database storage and operations. The data storage 111 stores any data used by the SIEM 110 to correlate and analyze event data.

The data sources 101 may include network devices, applications or other types of data sources operable to provide event data that may be analyzed. Event data may be captured in logs or messages generated by the data sources 101. For example, intrusion detection systems (IDSs), intrusion prevention systems (IPSs), vulnerability assessment tools, firewalls, anti-virus tools, anti-spam tools, encryption tools, and business applications may generate logs describing activities performed by the data source. Event data is retrieved from the logs and stored in the data storage 111. Event data may be provided, for example, by entries in a log file or a syslog server, alerts, alarms, network packets, emails, or notification pages. The data sources 101 may send messages to the SIEM 110 including event data.

Event data can include information about the source that generated the event and information describing the event. For example, the event data may identify the event as a user login or a credit card transaction. Other information in the event data may include when the event was received from the event source (“receipt time”). The receipt time may be a date/time stamp. The event data may describe the source, such as an event source is a network endpoint identifier (e.g., an IP address or Media Access Control (MAC) address) and/or a description of the source, possibly including information about the product's vendor and version. The data/time stamp, source information and other information may then be used for correlation performed by the event processing engine 121. The event data may include meta data for the event, such as when it took place, where it took place, the user involved, etc.

Examples of the data sources 101 are shown in FIG. 1 as Database (DB), UNIX, App1 and App2. DB and UNIX are systems that include network devices, such as servers, and generate event data. App1 and App2 are applications that generate event data. App1 and App2 may be business applications, such as financial applications for credit card and stock transactions, IT applications, human resource applications, or any other type of applications.

Other examples of data sources 101 may include security detection and proxy systems, access and policy controls, core service logs and log consolidators, network hardware, encryption devices, and physical security. Examples of security detection and proxy systems include IDSs, IPSs, multipurpose security appliances, vulnerability assessment and management, anti-virus, honeypots, threat response technology, and network monitoring. Examples of access and policy control systems include access and identity management, virtual private networks (VPNs), caching engines, firewalls, and security policy management. Examples of core service logs and log consolidators include operating system logs, database audit logs, application logs, log consolidators, web server logs, and management consoles. Examples of network devices includes routers and switches. Examples of encryption devices include data security and integrity. Examples of physical security systems include card-key readers, biometrics, burglar alarms, and fire alarms. Other data sources may include data sources that are unrelated to network security.

The connector 102 may include code comprised of machine readable instructions that provide event data from a data source to the SIEM 110. The connector 102 may provide efficient, real-time (or near real-time) local event data capture and filtering from one or more of the data sources 101. The connector 102, for example, collects event data from event logs or messages. The collection of event data is shown as “EVENTS” describing event data from the data sources 101 that is sent to the SIEM 110.

The SIEM 110 collects and analyzes the event data. Events can be cross-correlated with rules to create meta-events. Correlation includes, for example, discovering the relationships between events, inferring the significance of those relationships (e.g., by generating metaevents), prioritizing the events and meta-events, and providing a framework for taking action. The system (one embodiment of which is manifested as machine readable instructions executed by computer hardware such as a processor) enables aggregation, correlation, detection, and investigative tracking of activities. The system also supports response management, ad-hoc query resolution, reporting and replay for forensic analysis, and graphical visualization of network threats and activity.

ESAs 103 may comprise machine readable instructions that identify a data model and may include event processing instructions according to the data model. The data model may be specific to an application, industry, domain, etc.

The SIEM 110 may include modules that perform the functions described herein. Modules may include hardware and/or machine readable instructions. For example, the modules may include event processing engine 121, ESA engine 122 and event process extender 123. The event processing engine 121 processes events according to rules and instructions, which may be stored in the data storage 111. The event processing engine 121, for example, correlates events in accordance with rules, instructions and/or requests. For example, a rule indicates that multiple failed logins from the same user on different machines performed simultaneously or within a short period of time is to generate an alert to a system administrator. Another rule may indicate that two credit card transactions from the same user within the same hour, but from different countries or cities, is an indication of potential fraud. The event processing engine 121 may provide the time, location, and user correlations between multiple events when applying the rules.

The event process extender 123 places ESAs into an event processing workflow. The workflow includes the ESAs processing event data and the workflow may specify an order the ESAs process the event data. The ESA event processing may be performed in conjunction with event processing performed by the event processing engine 121. The event process extender 123 may determine whether to insert an ESA into the event processing workflow, for example, based on a flag that indicates the ESA is enabled for deployment. The flag may be set based on system environment variables.

In one example, the ESA includes a description file, which may be an XML file. The description file describes the service or functionality that a particular ESA provides and may provide event process order information and other information. The event process extender 123 may read the description file to determine where in the event data workflow (e.g., order for processing event data) the ESA belongs. For example, the ESA may be for pre-processing event data, such as including risk scores for an event, before the event data is processed by the event processing engine 121. The ESA engine 122 deploys the ESA in a pre-processing stage so event data received at the SIEM 110 from the data sources 101 is processed by the ESA before being processed by the event processing engine 121. If received event data is relevant to the processing of the ESA, the ESA may store the risk score with the event data for the particular transaction in a data model in the data storage 111. The description file may also identify whether the ESA processing is dependent on other ESA processing in order to determine which ESA processing is performed first.

The ESAs may also include ESA extenders. An ESA extender for an ESA may insert a plug-in, comprised of machine readable instructions, into the internal workflow processing performed by the ESA. The plug-in has a functionality, such as an event processing computation, that may be inserted into the current processing performed by the ESA. The ESA extender may comprise an interface, for example an application program interface, for receiving the plug-in and then the ESA extender may insert the plug-in into the internal processing workflow according to metadata, similar to the description file described above. The metadata may be provided with the plug-in and used by the ESA extender to determine the order for internal workflow processing. The ESA engine 122 may mange the plug-ins similar to managing the ESAs, such as performing dependency management, versioning, and lifecycle management. ESA management is described below.

The ESA engine 122 manages the ESAs 103. Managing may include ESA dependency management, versioning, and lifecycle management. Lifecycle management may include installing, running, and removing the ESAs 103. Developers may create the ESAs 103 and provide the ESAs to the SIEM 110, for example, via user interface 124. The user interface 124 may also be used for communicating or displaying reports or notifications about events and event processing to users. The user interface 124 may include a graphic user interface that may be web-based.

The ESAs 103 provided by the developers are stored in the data storage 111 by the ESA engine 122 and then further managed by the ESA engine 122. For example, the ESAs 103 are installed and executed when needed or requested and may be subsequently removed from the SIEM 110 but maintained in the data storage 111. The versioning may include tracking versions and running the most recent version.

The ESAs 103 may include machine readable instructions that provide event processing functionality. In one example, an ESA may include a pre-processing function prior to the event processing performed by the event processing engine 121. For example, an ESA is developed and stored in the data storage 111 for fraud detection of credit card transaction. The ESA marks a transaction as high risk if it includes a purchase amount greater than a threshold and it is out of the country of the credit card owner. In another example, the ESA calculates a risk score for an event (e.g., a credit card transaction) based on one or more fields in the event data. A high score may mean a higher probability of fraud. The score is sent with the event data to the event processing engine 121, and based on correlations with other events, the event processing engine 121 may identify one or more fraudulent transactions. ESAs may be stored for other types of data and for performing other types of processing.

An ESA may communicate with an external system to pre-process or post-process event data. For example, for pre-processing, if an external system generates a fraud score for a credit card transaction, the ESA may get the score from the external system and store it with the transaction data in the data storage 111. Then, event processing may be performed by the event processing engine 121

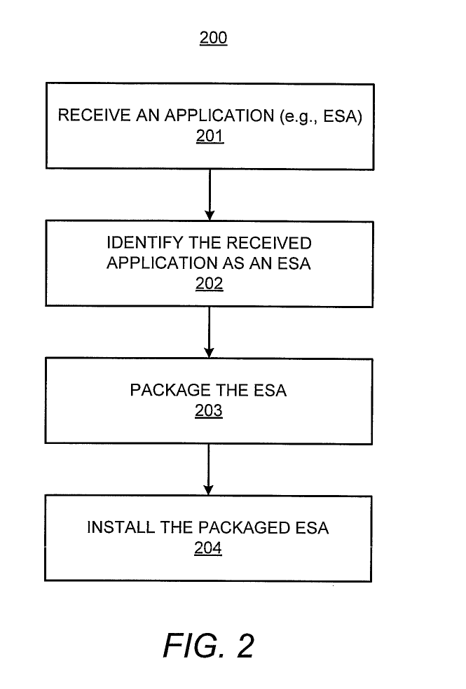

FIG. 2 illustrates a method 200 for installing an ESA, according to an embodiment. The method 200 and other methods described herein are described with respect to the SIEM 110 shown in FIG. 1 by way example. The methods may be performed by other systems.

At 201, an ESA is received at the SIEM 110. For example, a developer creates an application, for example in any computer language, to perform event processing and compiles it into JAVA byte code. The JAVA application may be sent as a JAR file to the SIEM 110 via the user interface 124.

At 202, the ESA engine 122 identifies the received application as an ESA. For example, the ESA is uploaded to the SIEM 110 as a specific type of resource, such as a file resource. By indicating the uploaded application is a file resource, the ESA engine 122 is able to identify the application as an ESA and not some other data or application that may be loaded into the SIEM 110.

At 203, the ESA engine 122 packages the ESA. Packaging may include indicating that the file resource is a resource that can be deployed, and may include formatting the file resource so it can be deployed by an SEM server for example using an :SIEM console provided via the user interface 124. The formatting may include a proprietary format.

At 204, the packaged ESA is installed in the SIEM 110. For example, the package ESA is stored in the data storage 111 and made available for deployment in a run-time environment. The packaged ESA may be marked as deployable so the SIEM 110 knows the ESA is available for deployment. Marking may include placing in a particular folder or including a marking as meta data for the ESA. In one example, the ESA may be shown to user in a list of deployable ESAs via the user interface 124. The user may select and drag and drop the ESA into a real-time module folder for deployment. The ESA is deployed by the ESA engine 112 for example by placing the ESA in the run-time environment of the SIEM 110 where the ESA is running and processing event data received at the SIEM 110 according to its functionality.

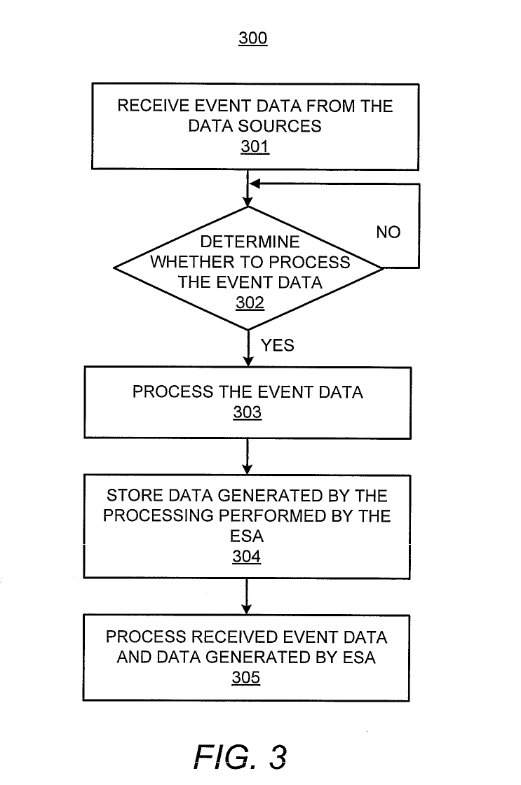

FIG. 3 illustrates a method 300 for event processing by an ESA, according to an embodiment. At 301, the SIEM 110 receives event data from the data sources 101. The event data may be received via connectors, such as the connector 102.

At 302, the ESA determines whether to process the event data. For example, if the event data is from a predetermined data source or connector, the ESA may determine that event data is relevant to its processing and processes the event data according to the machine readable instructions in the ESA. Determining whether the event data is relevant to the ESA may be based on other attributes of the event data, such as the device or source providing the event data, the time or location the event data was captured, or other attributes of the event data.

At 303, the ESA processes the event data. Processing may include performing calculations on the event data. In one example, the event data for an event is processed to generate a score for the event. Other types of processing may be performed.

In one example, at least some of the processing is performed by an external system. For example, the ESA may send credit card event data to an existing credit card fraud tracking system, which determines a score for a credit card transaction based on information in the transaction. The ESA may use this score to calculate another score or use the score as a factor to determine further risk assessment for the transaction.

At 304, data generated by the processing performed by the ESA is stored in the data storage 111 with the event data. For example, if the ESA calculates a fraud score, the fraud score is stored with the event data for that particular transaction.

Storing the data generated by the ESA with the event data may include storing the data in existing models used by the EVENT processing engine 121. For example, the event data received at the SIEM 110 may be stored in models in the data storage 111. For example, the models may include an asset model describing assets, such as network devices, and event data for those network devices. Another model may be an actor model describing users, such as user IDs, network account IDs, etc. The data generated by the ESA processing may be stored in a field in one or more of these models or referenced by a foreign key.

At 305, the event processing engine 121 processes received event data, which may include the data generated by the ESA. The event processing engine 121 may use the event data from the data models for event processing. Also, the event processing may be real-time. For example, the SIEM 110 may be receiving event data for thousands of events every second or every minute. The event data may be aggregated and processed by the event processing engine 122 according to rules stored in the data storage 111. For example, all network logins or all credit card transactions for a user for the past 3 minutes are aggregated and processed by the event processing engine 121 to detect a network security threat or credit card fraud. The aggregation of data may include aggregating the received event data and data generated by the ESAs 103, such as risk scores. The processing may include performing an action, such as generating an alert or disabling accounts, if one or more conditions are met that may be indicative of a network security threat or fraud. The conditions and actions are provided in the rules used by the event processing engine 122 for processing the event data. Also, non-real-time processing may be performed by the event processing engine 122. For example, a user may execute queries for event data via the user interface 124. The event processing engine 121 provides the query results to the user. The event processing engine 122 may also provide reports and other notifications regarding the event data via the user interface 124.

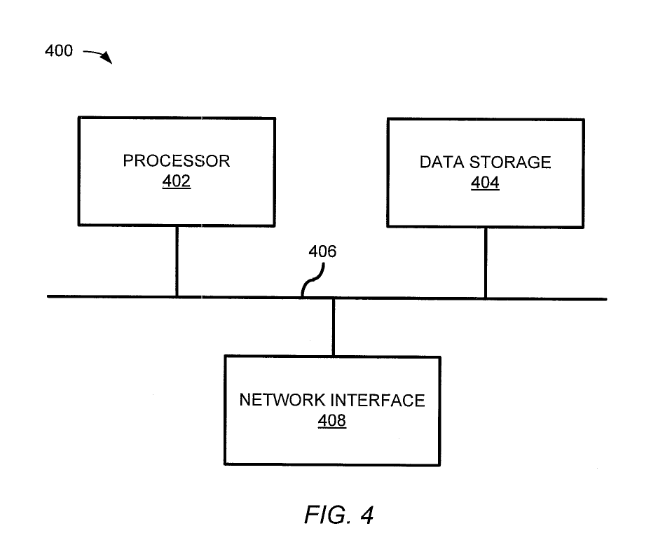

FIG. 4 shows a computer system 400 that may be used with the embodiments described herein. The computer system 400 represents a generic platform that includes components that may be in a server or another computer system or in components of a computer system. The computer system 400 may be used as a platform for the SIEM 110 shown in FIG. 1. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 404 or other hardware processing circuit that may implement or execute machine readable instructions performing some or all of the methods, functions and other processes described herein. Commands and data from the processor 402 are communicated over a communication bus 406. The computer system 400 also includes data storage 404, such as random access memory (RAM) or another type of data storage, where the machine readable instructions and data for the processor 404 may reside during runtime. Network interface 408 sends and receives data from a network. The computer system 400 may include other components not shown.

While the embodiments have been described with reference to examples, various modifications to the described embodiments may be made without departing from the scope of the claimed embodiments.

What is claimed is:

1. A system for extending event processing in an information and event management system, the system comprising:
an event stream application engine, executed by a processor, to manage event stream applications, wherein the managing event stream applications includes installing the event stream applications in the information and event management system, and the installed event stream applications are available to be deployed in an event data processing run-time environment to process event data received at the information and event management system; and
an event process extender to include the event stream applications in an event stream processing workflow, wherein each event stream application in the workflow is to process the event data if the event stream application determines the event data to be relevant to processing performed by the event stream application.

2. The system of claim 1 comprising:
an event processing engine to process the event stream data and to process data generated by the event stream applications processing the relevant event data, wherein the processing performed by the event processing engine includes aggregating the event data and the data generated by the event stream applications, and applying rules to the aggregated event data and the data generated by the event stream applications to determine whether to perform actions associated with the rules.

3. The system of claim 1, wherein to install the event stream applications, the event stream application engine is to receive the event stream applications uploaded to the information and event management system, package the event stream applications in a format whereby the event stream applications are deployable on a server for the information and event management system, and mark the packaged event stream applications as deployable.

4. The system of claim 3, further comprising a user interface, wherein the event stream application engine is to receive a user selection via the user interface of one of the event stream applications marked as deployable, and move the selected event stream application to the run-time environment in response to the user indicating via the user interface the selected event stream application is to be deployed.

5. The system of claim 3, wherein the event stream application engine is to deploy the event stream applications by placing the event stream applications in the event stream processing workflow that includes the event stream applications pre-processing the event data prior to an event processing engine processing the event data or post-processing the event data after the event processing engine processes the event data.

6. The system of claim 1, wherein one of the event stream applications is to communicate with an external system to have the external system process the event data, and the one event stream application is to store the processed event data with the event data in a data storage for the information and event management system.

7. The system of claim 1, wherein the information and event management system is to detect network security threats by processing the event data received from network devices, and the event stream applications provide processing of the event data to perform non-network-security functions.

8. The system of claim 1, wherein each of the event stream applications performs different calculations on the event data and stores results of the calculations in a data storage for the information and event management system, wherein the results are stored with the event data in the data storage.

9. The system of claim 1, wherein each of the event stream applications comprises an extender to receive a plugin and insert functionalities of the plugin into an internal workflow of the event stream application.

10. A method comprising:
receiving event stream applications at an information and event management system;
installing the event stream applications in the information and event management system;
determining an event stream processing workflow for the event stream applications, wherein the workflow identifies an order for the event stream applications to process event data received at the information and event management system from external data sources, and the order indicates whether each event stream application pre-processes or post process the event stream data relative to processing of the event data performed by an event stream application engine in the information and event management system;
deploying the event stream applications in a run-time environment in the information and event management system, wherein the deploying includes running each event stream application in the workflow to process event data if the event stream application determines the event data is relevant to the event stream application; and
storing data generated by the event stream applications in response to processing the relevant event data, wherein the data generated by the event stream applications is stored with the relevant event data.

11. The method of claim 10, wherein processing the event data by the event stream application engine comprises:
aggregating the event data and the data generated by the event stream applications pre-processing the event data, and applying rules to the aggregated event data to determine whether to perform actions associated with the rules.

12. The method of claim 10, wherein one of the event stream applications is to communicate with an external system to have the external system process the event data relevant to the one event stream application.

13. The method of claim 10, wherein installing the event stream applications comprises:
receiving the event stream applications uploaded to the information and event management system; and
packaging the event stream applications in a format whereby the event stream applications are deployable on a server for the information and event management system.

14. The method of claim 13, wherein deploying the event stream applications comprises:
receiving a user selection via a user interface of the event stream applications from a plurality of event stream applications displayed on the user interface; and
moving the selected event stream applications to the run-time environment in response to the user indicating via the user interface the selected event stream applications are to be deployed.

15. A non-transitory computer readable medium storing machine readable instructions that when executed by a processer perform instructions comprising instructions to:
receive event stream applications at an information and event management system;
install the event stream applications in the information and event management system;
determine an event stream processing workflow for the event stream applications, wherein the workflow identifies an order for the event stream applications to process event data received at the information and event management system from external data sources, and the order indicates whether each event stream application pre-processes or post process the event stream data relative to processing of the event data performed by an event stream application engine in the information and event management system;
deploy the event stream applications in a run-time environment in the information and event management system, wherein the deploying includes running each event stream application in the workflow to process event data if the event stream application determines the event data is relevant to the event stream application; and
store data generated by the event stream applications in response to processing the relevant event data, wherein the data generated by the event stream applications is stored with the relevant event data.
